(19) United States
(12) Patent Application Publication
(10) Pub. No.: US 2016/0101393 A1
(43) Pub. Date: Apr. 14, 2016

(54) CAR WASH CHEMICAL DELIVERY DEVICES, SYSTEMS, AND ASSOCIATED METHODS

(71) Applicant: Dustin Jensen, Draper, UT (US)

(72) Inventor: Dustin Jensen, Draper, UT (US)

(21) Appl. No.: 14/878,881

(22) Filed: Oct. 8, 2015

Related U.S. Application Data
(60) Provisional application No. 62/063,436, filed on Oct. 14, 2014.

(51) Int. Cl. B01F 5/04; B01F 3/08

(52) U.S. Cl. CPC B01F 5/04; B01F 5/0413; B01F 3/0865; B01F 3/088; B01F 2215/0077

(57) ABSTRACT

A car wash chemical delivery device can include an inlet manifold having a water inlet, a plurality of water outlets, and an inlet chamber to receive water from the water inlet and distribute the water via the plurality of water outlets. The car wash chemical delivery device can also include a plurality of chemical injectors. Each chemical injector can be fluidly coupled to corresponding water outlets and have a chemical inlet to introduce a car wash chemical into the water to form a mixture. In addition, the car wash chemical delivery device can include an outlet manifold having a plurality of mixture inlets, a mixture outlet, and an outlet chamber. Each mixture inlet can be fluidly coupled to a corresponding one of the plurality of chemical injectors. The outlet chamber can receive one or more mixtures from the plurality of chemical injectors for delivery to a car wash tool.

### BACKGROUND

Current vehicle wash equipment systems rely on one or more dilution or mixing steps to dilute highly-concentrated solutions with water before the water-diluted solutions are suitable for end use or application to the vehicle in a washing process. In addition, many chemical delivery systems have space requirements. For example, in the typical car wash there may be a need for a tank for a pre-mixed solution, multiple pumps, and valves associated with the variety of chemicals, detergents and other rinsing or washing agents. Generally, a “hydrominder” is used, in conjunction with a pump and valves to take a chemical from a tank or reservoir, to mix the chemical with water and deposit the solution in an additional tank before the diluted solution is pumped through a pump, typically air driven, and applied through a sprayer. This process, and the associated equipment, may be required for each individual chemical employed by the system. Because most car washes utilize several detergents or other chemicals, the process results in a large quantity of tanks, pumps, valves, piping, and a significant space requirement.

### BRIEF DESCRIPTION OF DRAWINGS

FIG. 1 is a schematic diagram of a car wash chemical delivery system, in accordance with an example of the present disclosure.

FIG. 2A is a perspective view of a car wash chemical delivery device, in accordance with an example of the present disclosure.

FIG. 2B is a side view of the car wash chemical delivery device of FIG. 2A.

FIG. 3 is a car wash chemical delivery system in accordance with another example of the present disclosure.

### DETAILED DESCRIPTION

Reference will now be made to the exemplary embodiments, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention. It is also to be understood that the terminology used herein is used for the purpose of describing particular embodiments only. The terms are not intended to be limiting unless specified as such.

It is noted that, as used in this specification and the appended claims, the singular forms “a,” “an,” and “the” include plural referents unless the content clearly dictates otherwise.

In describing embodiments of the present disclosure, reference will be made to “first” or “second” as they relate to spacer threaded portions or other structures, for example. It is noted that these are merely relative terms, and a spacer threaded portion described or shown as a “first” threaded portion could just as easily be referred to a “second” threaded portion, and such description is implicitly included herein.

Dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

In accordance with these definitions and embodiments of the present disclosure, a discussion of the various systems and methods is provided including details associated therewith. This being said, it should be noted that various embodiments will be discussed as they relate to the systems and methods. Regardless of the context of the specific details as they are discussed for any one of these embodiments, it is understood that such discussion relates to all other embodiments as well.

The present disclosure is drawn to a car wash chemical delivery device. The car wash chemical delivery device can comprise an inlet manifold having a water inlet, a plurality of water outlets, and an inlet chamber to receive water from the water inlet and distribute the water via the plurality of water outlets. The car wash chemical delivery device can also comprise a plurality of chemical injectors. Each chemical injector can be fluidly coupled to a corresponding one of the plurality of water outlets and have a chemical inlet to introduce a car wash chemical into the water to form a mixture. Additionally, the car wash chemical delivery device can comprise an outlet manifold having a plurality of mixture inlets, a mixture outlet, and an outlet chamber. Each mixture inlet can be fluidly coupled to a corresponding one of the plurality of chemical injectors. The outlet chamber can receive one or more mixtures from the plurality of chemical injectors for delivery to a car wash tool.

In one aspect, the disclosure provides a car wash chemical delivery system. The system can comprise a water source, a plurality of car wash chemical sources, and a car wash chemical delivery device. The car wash chemical delivery device can include an inlet manifold having a water inlet, a plurality of water outlets, and an inlet chamber to receive water from the water source via the water inlet and distribute the water via the plurality of water outlets. The car wash chemical delivery device can further include a plurality of chemical injectors. Each chemical injector can be fluidly coupled to a corresponding one of the plurality of water outlets and have a chemical inlet to introduce a car wash chemical into the water from one of the plurality of car wash chemical sources to form a mixture. In addition, the car wash chemical delivery device can include an outlet manifold having a plurality of mixture inlets, a mixture outlet, and an outlet chamber. Each mixture inlet can be fluidly coupled to a corresponding one of the plurality of chemical injectors. The outlet chamber can receive one or more mixtures from the plurality of chemical injectors for delivery to a car wash tool.

In another aspect, the disclosure provides a method for delivering a car wash chemical to a car wash tool. The method can comprise providing water to an inlet manifold having a water inlet, a plurality of water outlets, and an inlet chamber to receive the water via the water inlet and distribute the water via the plurality of water outlets. The method can also comprise providing a plurality of car wash chemicals to a plurality of chemical injectors, each chemical injector being fluidly coupled to a corresponding one of the plurality of water outlets and having a chemical inlet to introduce one of the plurality of car wash chemicals into the water to form a mixture. Additionally, the method can comprise fluidly coupling a car wash tool to an outlet manifold having a plurality of mixture inlets, a mixture outlet, and an outlet chamber, each mixture inlet being fluidly coupled to a corresponding one of the plurality of chemical injectors, wherein the outlet chamber receives one or more mixtures from the plurality of chemical injectors for delivery to the car wash tool.

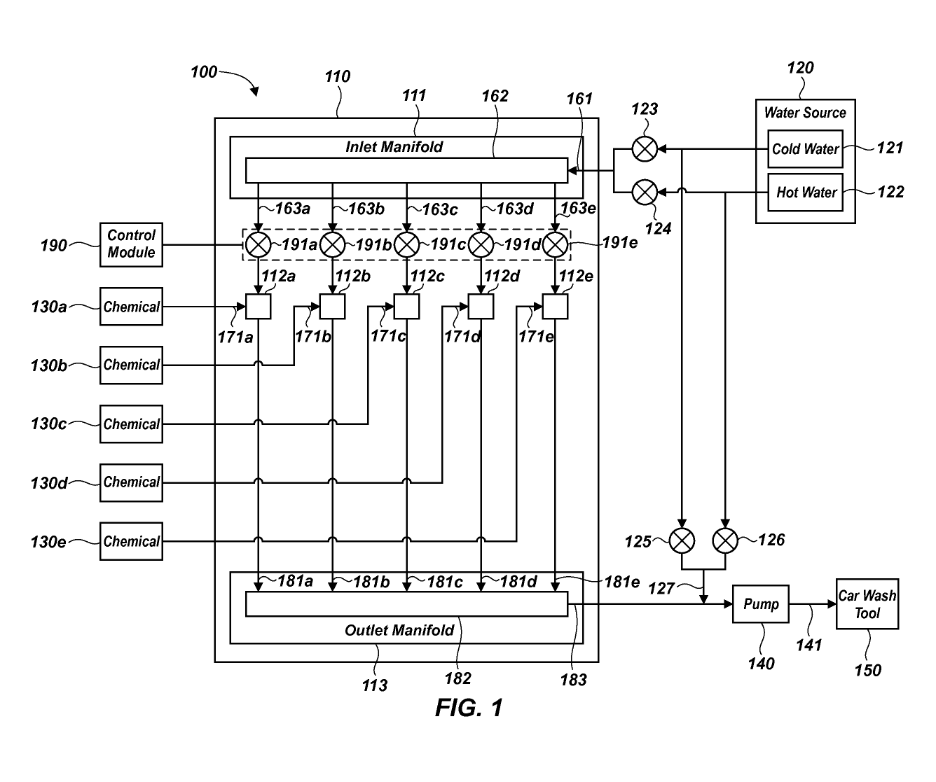

FIG. 1 shows a schematic diagram of a car wash chemical delivery system 100, in accordance with an example of the present disclosure. As used herein, a car wash chemical can include a detergent (i.e., soaps, surfactants, etc.), a conditioner, a wax, or any other suitable chemical or additive for a car wash that can be mixed with water. In general, the car wash chemical delivery system 100 can include a car wash chemical delivery device 110, a water source 120, car wash chemical sources 130a-e, a pump 140, and a car wash tool 150. The car wash tool can include a brush and/or a spray gun applicator or other type of tool or applicator suitable for a car wash.

The water source 120 can provide cold water 121 and/or hot water 122 to the car wash chemical delivery device 110. Valves 123, 124 can be used to control the flow of cold and/or hot water to the car wash chemical delivery device 110. The valves 123, 124 can comprise any suitable type of valve. In one aspect, the valves 123, 124 can be actuated by solenoids.

The car wash chemical delivery device 110 can include an inlet manifold 111, chemical injectors 112a-e, and an outlet manifold 113. The inlet manifold 111 can have a water inlet 161, an inlet chamber 162, and water outlets 163a-e. The inlet chamber 162 can receive water from the water source 120 via the water inlet 161 and distribute the water via the water outlets 163a-e to the chemical injectors 112a-e. Each chemical injector 112a-e can be fluidly coupled to a corresponding water outlet 163a-e from the inlet manifold 111 and can have a chemical inlet 171a-e to introduce a car wash chemical into the water from one of the car wash chemical sources 130a-e to form a mixture with the water. It should be recognized that any suitable number of chemical injectors can be utilized with a corresponding number of chemical sources. The chemical injectors 112a-e can include any of a variety of fittings, connectors, quick-couplers, or quick-connect fittings appropriate for handling detergents or other concentrated chemicals.

The chemical injectors 112a-e can supply concentrated individual chemicals to the flow of water from the water outlets 163a-e through a chemical supply hose connected to the chemical sources 130a-e, which may comprise barrels containing chemicals. The supplied chemicals can be diluted with water from the water outlets 163a-e of the inlet manifold 111. The diluted chemical mixture can then be supplied to the outlet manifold 113. The outlet manifold 113 can have mixture inlets 181a-e, an outlet chamber 182, and a mixture outlet 183. Each mixture inlet 181a-e can be fluidly coupled to a corresponding chemical injector 112a-e. The outlet chamber 182 can receive one or more mixtures from the chemical injectors such that water along with appropriate concentrations of diluted and mixed chemical product can be dispensed out a single discharge line 141 for delivery to the car wash tool 150.

The chemical mixtures can be fed to the car wash tool 150 through a pump, which can facilitate delivery of the chemical mixtures to the car wash tool at a suitable pressure and serve to further mix the chemicals and the water. In one aspect, the pump 140 can be fluidly coupled to the outlet manifold 113 and the car wash tool 150 and disposed between the outlet manifold 113 and the car wash tool 150. The pump 140 can be of any suitable pump type or design. For example, the pump 140 can comprise a piston, an impeller, a diaphragm, a centrifugal booster, multiple stages, or any other suitable pump feature or design. In one aspect, the chemical delivery system 100 can utilize only a single pump, although it should be recognized that multiple pumps can be used, such as in a parallel arrangement to provide redundancy and/or to increase capacity. In one aspect, water from the water supply 120 can be added to the chemical mixture via a supplemental water inlet 127 at the pump or before entering the pump. Water can be added to achieve a desired chemical concentration and/or to ensure that the pump is supplied with enough fluid to protect the pump from damage during operation. Valves 125, 126 can control the flow of cold and/or hot water to the pump.

In one aspect, one or more of the chemical injectors 112a-e can be configured to introduce a chemical into the water via a venturi effect. Thus configured, as long as there is a suitable difference in pressure across the chemical injectors 112a-e, the chemical injectors can draw a concentrated chemical in through the chemical inlet 171a-e and mix the chemical with the water provided from the water outlets 163a-e of the manifold 111. It should be recognized that venturi ports of various sizes and configurations can produce various suction pressures at the chemical inlets 171a-e. The selection of individual chemical injectors can generally be based on the chemical concentration desired and the flow rate and/or pressure of the water through the system. The resulting mixtures can then be directed from the chemical injectors 171a-e to the outlet manifold 113. The use of chemical injectors 112a-e having a venturi configuration can avoid exposing moving parts to the concentrated chemicals such that issues regarding chemical compatibility and wear can be avoided.

In one aspect, valves 191a-e can be associated with one or more of the water outlets 163a-e of the inlet manifold 111 to control water flow to the corresponding chemical injectors 112a-e. One or more of the valves 191a-e can be opened as desired to allow water to flow from the water outlets 163a-e through the chemical injectors 112a-e, thus mixing with chemicals introduced into the water flow stream by the corresponding chemical injectors. One or more mixtures can then enter the outlet manifold 113, which is connected to the suction side of the pump 140, to supply the mixture to the car wash tool 150. In one aspect, opening the valves 191a-e can allow water to flow past venturis of the chemical injectors 112a-e, which due to a reduced pressure at the suction side of the pump 140, can draw chemicals into the respective water flow streams. In other words, the suction created by the pump can draw water through one or more open valves 191a-e along with chemicals from the supplies 130a-e via the chemical injector 112a-e venturis that are associated with open valves 191 a-e. Thus, one or more of the valves 191 a-e, which are disposed between the water outlets 163a-e and the chemical injectors 112a-e, can be selectively opened to mix a selected chemical with the water exiting the inlet manifold 111 via the corresponding water outlet 163a-e. Further mixing of the one or more chemicals and water can occur in the outlet manifold chamber 182. The valves 191a-e can comprise any suitable type of valve. In one aspect, the valves 191a-e can be actuated by solenoids. In a particular aspect, the valves 191 a-e can be solenoid-operated needle valves.

In one aspect, the car wash chemical delivery system 100 can include a control module 190 to control operation of the valves 191a-e. The control module 190 can be used to convey the user-selected commands as to the cleaning additives desired, such as by controlling the valves 191 a-e to allow water to flow through one or more specific chemical injectors 112a-e thereby introducing the appropriate additive into the flow of water for delivery to the car wash tool 150. The control module 190 can be programmable and can include multiple algorithms that can be selected for particular needs, thus allowing the system to be adjusted automatically and quickly as needed and as different car wash options are selected by an operator.

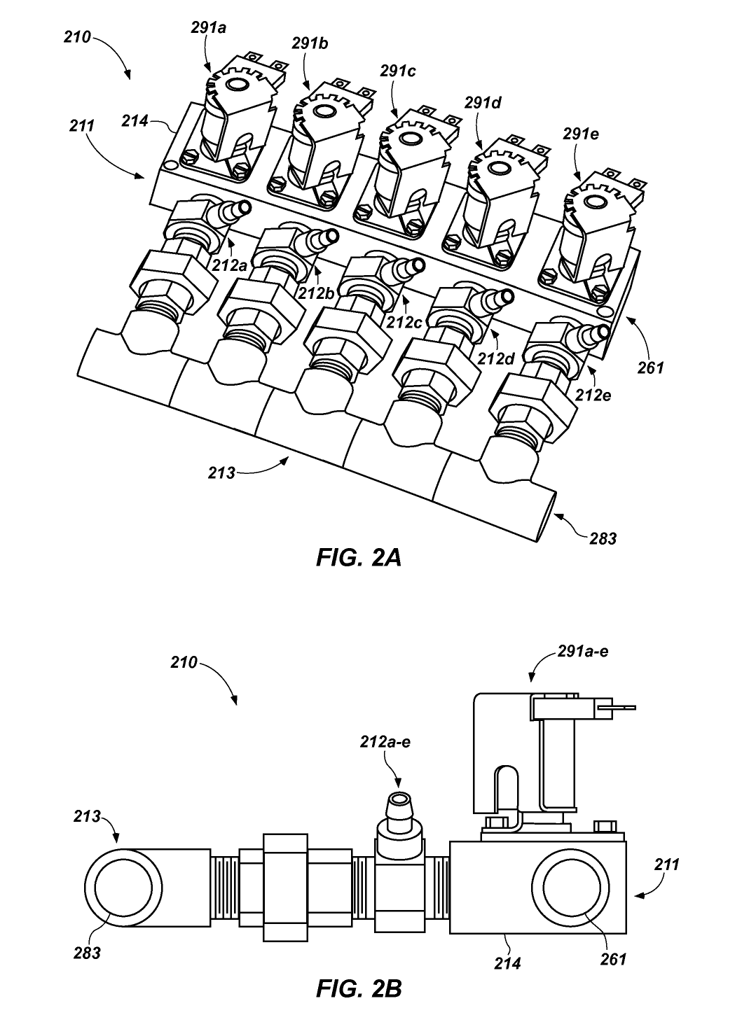

FIGS. 2A and 2B illustrate a car wash chemical delivery device 210 in accordance with another example of the present disclosure. The car wash chemical delivery device 210 shown in these figures illustrates several aspects of the car wash chemical delivery device 110 represented in the schematic diagram of FIG. 1. For example, the device 210 includes an inlet manifold 211, a plurality of electrically actuated solenoid valves 291a-e, a plurality of chemical injectors 212a-e, and an outlet manifold 213. In general, water enters the inlet manifold 211 by a water inlet 261, and passes through one or more of the chemical injectors 212a-e as controlled by the valves 291a-e, where one or more chemicals is mixed with the water. The water and chemical mixture then flows out of the outlet manifold 213 via mixture outlet 283. In this case, the inlet manifold 211 can comprise an inlet manifold body 214 that is configured to integrate the valves 291 a-e within the inlet manifold 211. By controlling the state of the solenoids, one or more of the valves 291 a-e can be opened to direct water into the corresponding individual chemical injectors 212a-e. Each chemical injector generally includes a venturi configuration for introducing the chemical into the water. The chemical injectors 212a-e can include any of a variety of fittings, connectors, quick-couplers, or quick-connect fittings to introduce a car wash chemical into the water from one of the car wash chemical sources.

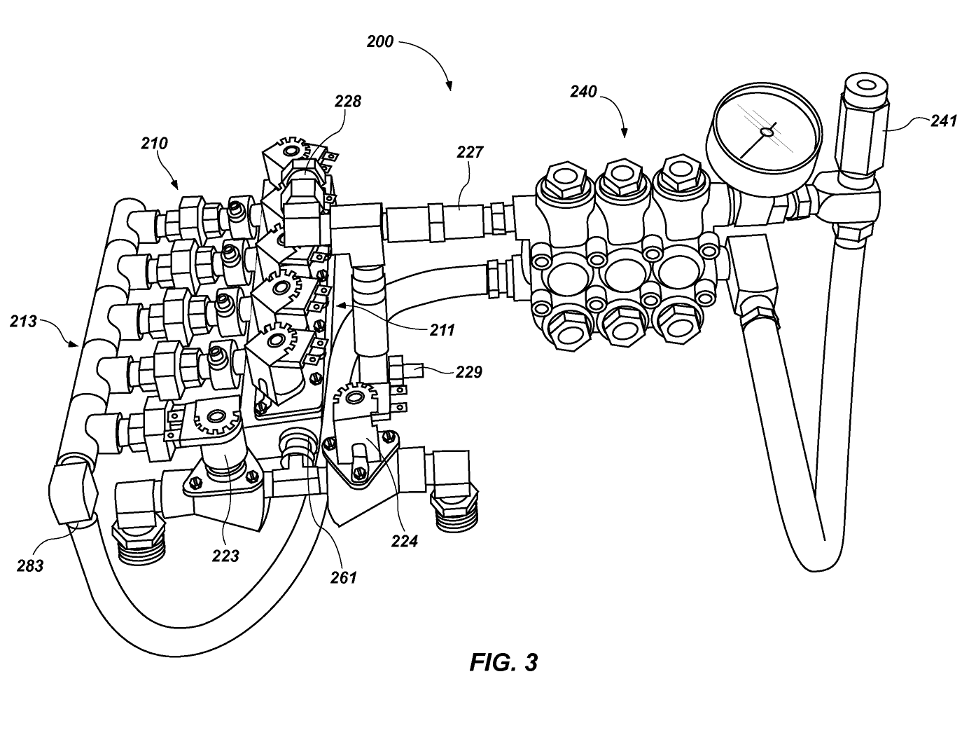

FIG. 3 illustrates a car wash chemical delivery system 200 in accordance with another example of the present disclosure. The car wash chemical delivery system 200 shown in this figure illustrates several aspects of the car wash chemical delivery system 100 represented in the schematic diagram of FIG. 1. For example, the system 200 includes the car wash chemical delivery device 210 of FIGS. 2A and 2B and a pump 240 coupled to the outlet 283 of the outlet manifold 213. Electrically actuated solenoid valves 223, 224 for controlling water flow from a water source to the inlet 261 of the inlet manifold 211 of the device 210 are also shown. The valves 223, 224 can control water flow from multiple sources and/or at different temperatures. Water from a water source can also be added to the chemical mixture that has exited the car wash chemical delivery device 210 via a supplemental water inlet 127 at the pump 240. Two inlet branches 128, 129 can accommodate water from multiple sources and/or at different temperatures. Diluted and mixed chemical product can be dispensed out a single discharge line 241 for delivery at a suitable pressure to a car wash tool.

Furthermore, in accordance with one embodiment of the present invention, a method for delivering a car wash chemical to a car wash tool is disclosed. The method can comprise providing water to an inlet manifold having a water inlet, a plurality of water outlets, and an inlet chamber to receive the water via the water inlet and distribute the water via the plurality of water outlets. The method can also comprise providing a plurality of car wash chemicals to a plurality of chemical injectors, each chemical injector being fluidly coupled to a corresponding one of the plurality of water outlets and having a chemical inlet to introduce one of the plurality of car wash chemicals into the water to form a mixture. Additionally, the method can comprise fluidly coupling a car wash tool to an outlet manifold having a plurality of mixture inlets, a mixture outlet, and an outlet chamber, each mixture inlet being fluidly coupled to a corresponding one of the plurality of chemical injectors, wherein the outlet chamber receives one or more mixtures from the plurality of chemical injectors for delivery to the car wash tool. It is noted that no specific order is required in this method, though generally in one embodiment, these method steps can be carried out sequentially.

In one aspect of the method, at least one of the plurality of chemical injectors is configured to introduce the chemical into the water via a venturi effect. In another aspect, the method can further comprise controlling water flow through at least one of the plurality of water outlets to control water flow to the corresponding chemical injector.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Furthermore, the terms “comprises,” “comprising,” “includes,” “including,” “having,” and the like can have the meaning ascribed to them in U.S. Patent law, and are generally interpreted to be open ended terms. The term “consisting of” is a closed term, and includes only the devices, methods, compositions, components, structures, steps, or the like specifically listed, and that which is in accordance with U.S. Patent law. “Consisting essentially of” or “consists essentially” or the like, when applied to devices, methods, compositions, components, structures, steps, or the like encompassed by the present disclosure, refers to elements like those disclosed herein, but which may contain additional structural groups, composition components, method steps, etc. Such additional structural groups, composition components, methods steps, etc., however, do not materially affect their basic and novel characteristic(s) compared to those of the corresponding structural groups, composition components, methods steps, etc. disclosed herein. When using an open ended term, like “comprising” or “including,” it is understood that direct support should be afforded also to “consisting essentially of” language as well as “consisting of” language as if stated explicitly.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A car wash chemical delivery device, comprising:
an inlet manifold having a water inlet, a plurality of water outlets, and an inlet chamber to receive water from the water inlet and distribute the water via the plurality of water outlets;
a plurality of chemical injectors, each chemical injector being fluidly coupled to a corresponding one of the plurality of water outlets and having a chemical inlet to introduce a car wash chemical into the water to form a mixture; and
an outlet manifold having a plurality of mixture inlets, a mixture outlet, and an outlet chamber, each mixture inlet being fluidly coupled to a corresponding one of the plurality of chemical injectors, wherein the outlet chamber receives one or more mixtures from the plurality of chemical injectors for delivery to a car wash tool.

2. The device of claim 1, wherein at least one of the plurality of chemical injectors is configured to introduce the chemical into the water via a venturi effect.

3. The device of claim 1, further comprising a valve associated with at least one of the plurality of water outlets to control water flow to the corresponding chemical injector.

4. The device of claim 3, further comprising a solenoid to actuate the valve.

5. The device of claim 3, further comprising a control module to control operation of the valve.

6. The device of claim 3, wherein the inlet manifold includes the valve.

7. A car wash chemical delivery system, comprising:
a water source;
a plurality of car wash chemical sources; and
a car wash chemical delivery device, including:
an inlet manifold having a water inlet, a plurality of water outlets, and an inlet chamber to receive water from the water source via the water inlet and distribute the water via the plurality of water outlets,
a plurality of chemical injectors, each chemical injector being fluidly coupled to a corresponding one of the plurality of water outlets and having a chemical inlet to introduce a car wash chemical into the water from one of the plurality of car wash chemical sources to form a mixture, and
an outlet manifold having a plurality of mixture inlets, a mixture outlet, and an outlet chamber, each mixture inlet being fluidly coupled to a corresponding one of the plurality of chemical injectors, wherein the outlet chamber receives one or more mixtures from the plurality of chemical injectors for delivery to a car wash tool.

8. The system of claim 7, wherein the water source comprises a cold water source and a hot water source.

9. The system of claim 7, further comprising a pump to facilitate delivery of the one or more mixtures to the car wash tool.

10. The system of claim 9, wherein the pump is fluidly coupled to the outlet manifold and the car wash tool between the outlet manifold and the car wash tool.

11. The system of claim 7, wherein at least one of the plurality of chemical injectors is configured to introduce the chemical into the water via a venturi effect.

12. The device of claim 7, further comprising a valve associated with at least one of the plurality of water outlets to control water flow to the corresponding chemical injector.

13. The device of claim 12, further comprising a solenoid to actuate the valve.

14. The device of claim 12, further comprising a control module to control operation of the valve.

15. The device of claim 12, wherein the inlet manifold includes the valve.

16. A method for delivering a car wash chemical to a car wash tool, comprising:
providing water to an inlet manifold having a water inlet, a plurality of water outlets, and an inlet chamber to receive the water via the water inlet and distribute the water via the plurality of water outlets;
providing a plurality of car wash chemicals to a plurality of chemical injectors, each chemical injector being fluidly coupled to a corresponding one of the plurality of water outlets and having a chemical inlet to introduce one of the plurality of car wash chemicals into the water to form a mixture; and
fluidly coupling a car wash tool to an outlet manifold having a plurality of mixture inlets, a mixture outlet, and an outlet chamber, each mixture inlet being fluidly coupled to a corresponding one of the plurality of chemical injectors, wherein the outlet chamber receives one or more mixtures from the plurality of chemical injectors for delivery to the car wash tool.

17. The method of claim 16, wherein at least one of the plurality of chemical injectors is configured to introduce the chemical into the water via a venturi effect.

18. The method of claim 17, further comprising the step of introducing the chemical into the water via the venturi effect.

19. The method of claim 16, further comprising controlling water flow through at least one of the plurality of water outlets to control water flow to the corresponding chemical injector.

20. The method of claim 16, further comprising the step of pumping the one or more mixtures to the car wash tool.
